(19) United States
(12) Patent Application Publication
(10) Pub. No.: US 2016/0149317 A1
(43) Pub. Date: May 26, 2016

(54) Communication Apparatus With Improved Radiated Spurious Emission And Loss

(71) Applicant: MediaTek Inc., Hsinchu (TW)

(72) Inventor: Chen-Fang Tai, New Taipei (TW)

(21) Appl. No.: 14/981,731

(22) Filed: Dec. 28, 2015

(51) Int. Cl. H01Q 23/00; H01Q 1/50; H01Q 1/48

(52) U.S. Cl. CPC H01Q 23/00; H01Q 1/48; H01Q 1/50

(57) ABSTRACT

Examples of a tunable antenna and various implementations thereof are described. The tunable antenna may include a radiator and one or more varactors. The radiator may include at least one feeding port and at least one shorting port. Each of the one or more varactors may be coupled to the radiator and configured to operate in either an isolation state or a connection state when the tunable antenna operates in a radio-frequency (RF) frequency range.

### TECHNICAL FIELD

The present disclosure is generally related to tunable antennas and, more particularly, to a tunable antenna for communication apparatuses to achieve improved radiated spurious emission and loss.

### BACKGROUND

Unless otherwise indicated herein, approaches described in this section are not prior art to the claims listed below and are not admitted to be prior art by inclusion in this section.

Communication apparatuses including mobile communication apparatuses such as smartphones typically include a tunable antenna and a tunable circuit for tunable matching. The matching of the tunable circuit may be changed to improve transmission bandwidth. The length or grounding of the tunable antenna may be changed to improve efficiency of bandwidth usage. Often time switches and/or diodes are employed in conventional tunable antennas for this purpose. However, switches and diodes tend to have poor linearity which leads to radiated spurious emission and de-sense problems. Moreover, there may be loss of switch/diode impact on efficiency of the tunable antenna. Undesirably, the communication apparatus may fail to operate in compliance with specifications set forth by industry standard bodies and/or wireless/cellular network operators. Furthermore, employment of conventional tunable antennas tends to be limited to applications of low transmit power.

### SUMMARY

The following summary is illustrative only and is not intended to be limiting in any way. That is, the following summary is provided to introduce concepts, highlights, benefits and advantages of the novel and non-obvious techniques described herein. Select, not all, implementations are further described below in the detailed description. Thus, the following summary is not intended to identify essential features of the claimed subject matter, nor is it intended for use in determining the scope of the claimed subject matter.

Implementations in accordance with the present disclosure utilize one or more varactors in a tunable antenna in places where switches and diodes would be employed in conventional designs of tunable antennas. Advantageously, with varactors functioning as voltage-controlled capacitors, the tunable antenna in accordance with the present disclosure can achieve high linearity, high Q factor and low loss. That is, the proposed tunable antenna has good linearity and no radiated spurious emission issues, and there is low loss due to the employment of varactor(s). Moreover, the proposed tunable antenna may be used for both transmitters and receivers as well as for high and low transmission power antennas. Furthermore, the proposed tunable antenna is compliant with the specifications of various wireless/cellular network operators.

In one example implementation, a communication apparatus may include a tunable antenna. The tunable antenna may include a radiator and one or more varactors. The radiator may include at least one feeding port and at least one shorting port. Each of the one or more varactors may be coupled to the radiator and configured to operate in either an isolation state or a connection state when the tunable antenna operates in a radio-frequency (RF) frequency range.

In another example implementation, a communication apparatus may include a tunable antenna and a tunable circuit. The tunable antenna may include a radiator, a first varactor and a second varactor. The radiator may include at least one feeding port and at least one shorting port. The radiator may also include a gap or split. The first varactor may be coupled between a respective one of the at least one shorting port of the radiator and an electrical ground. The first varactor may be configured to operate in either an isolation state or a connection state when the tunable antenna operates in a RF frequency range. The second varactor may be disposed in the gap or split of the radiator. The second varactor may be configured to operate in either the isolation state or the connection state when the tunable antenna operates in the RF frequency range. The tunable circuit may be coupled to the tunable antenna and configured to match one or more ranges of frequencies of the tunable antenna. The tunable circuit may include at least one matching circuit. The at least one matching circuit may include a third varactor coupled between a respective one of the at least one feeding port and a RF port. The third varactor may be configured to operate in either the isolation state or the connection state when the tunable antenna operates in the RF frequency range.

With the utilization of varactors, good linearity can be achieved without producing undesired radiated spurious emission (RSE) issues. In addition, loss of signal strength can be reduced. In addition, the antenna can operate under both transmitting and radiating (Tx and Rx) modes. In addition, high Tx power antenna and low TX power antenna may be also available. Consequently, design specification or requirements may be more readily met.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example tunable antenna in accordance with an implementation of the present disclosure.

FIG. 2 is a diagram of an example apparatus in accordance with an implementation of the present disclosure.

FIG. 3 is a diagram of an example apparatus in accordance with another implementation of the present disclosure.

### DETAILED DESCRIPTION OF PREFERRED EMBODIMENTS

### Overview

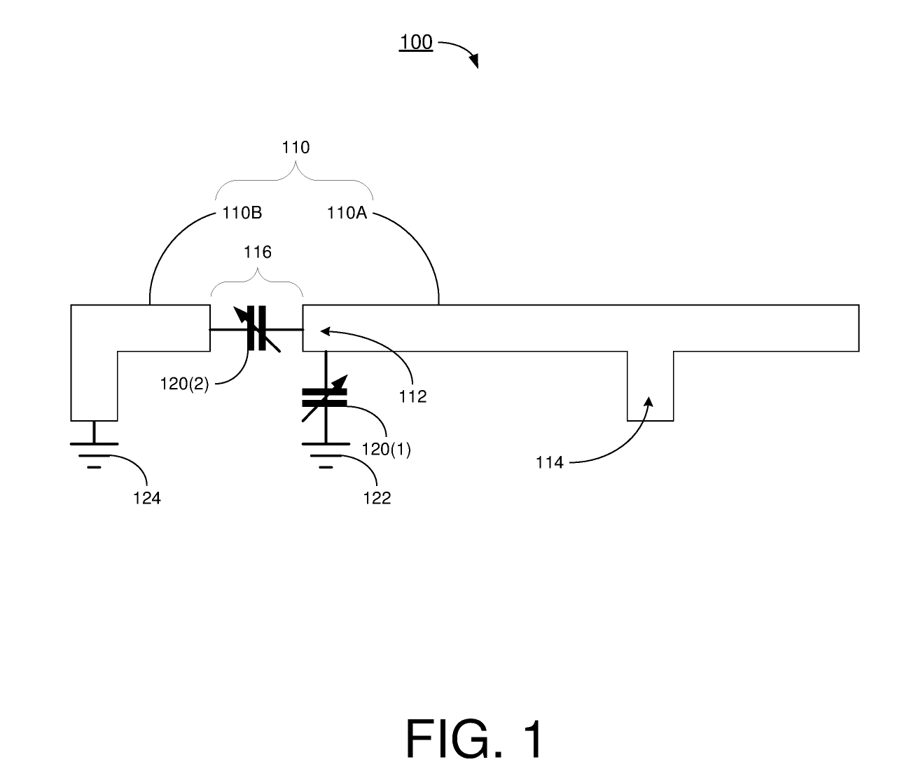

FIG. 1 illustrates an example tunable antenna 100 in accordance with an implementation of the present disclosure. Tunable antenna 100 may include a radiator 110 and one or more first varactors. Radiator 110 may include at least one feeding port 114 and at least one shorting port 112. Radiator 110 may also include a gap or split 116. The gap or split 116 may separate radiator 110 into two portions, namely first portion 110A and second portion 110B. Radiator 110 may be an electrically conductive component such as, for example, a metallic frame made of a metallic material. For simplicity and not to obscure the concept intended to be conveyed in FIG. 1, one feeding port 114 and one shorting port 112 instead of multiple feeding ports and/or multiple shorting ports are shown in FIG. 1, although implementations in which radiator 110 having multiple feeding ports and/or multiple shorting ports are also within the scope of the present disclosure.

Varactors may be used as voltage-controlled capacitors, and tend to possess desirable characteristics such as high linearity, high Q factor and low loss. Each of the one or more first varactors may be coupled to radiator 110 and configured to operate in either an isolation state or a connection state when tunable antenna 100 operates in a RF frequency range which may include one or more ranges of frequencies. For instance, when each of the one or more first varactors is in the connection state, the respective first varactor may be in a high-capacitance state (e.g., with low or no bias) such that the respective first varactor presents a low impedance path, thereby rendering an electrical connection. Moreover, when each of the one or more first varactors is in the isolation state, the respective first varactor may be reverse biased and thus having its capacitance abruptly decreased to result in a high impedance path, thereby causing an electrical isolation. For simplicity and not to obscure the concept intended to be conveyed in FIG. 1, a quantity of two of first varactors—namely first varactor 120(1) and first varactor 120(2)—are shown in FIG. 1 although implementations in which tunable antenna 100 having a different quantity of first varactors are also within the scope of the present disclosure.

At least one of the one or more first varactors may include one terminal coupled to a respective shorting port of the at least one shorting port 114 of radiator 110, and may also include another terminal coupled to an electrical ground 122. For instance, as shown in FIG. 1, one terminal of first varactor 120(1) may be coupled to shorting port 112 of radiator 110 and another terminal of first varactor 120(1) may be coupled to electrical ground 122. When each of the at least one first varactor operates in the isolation state, the respective first varactor may electrically isolate radiator 110 from electrical ground 122. When each of the at least one first varactor operates in the connection state, the respective first varactor may electrically connect radiator 110 to electrical ground 122. For instance, when first varactor 120(1) operates in the isolation state, first varactor 120(1) may electrically isolate radiator 110 from electrical ground 122. Moreover, when first varactor 120(1) operates in the connection state, first varactor 120(1) may electrically connect radiator 110 to electrical ground 122.

Additionally or alternatively, one of the at least one first varactor of the one or more first varactors may be disposed in the gap or split 116 of radiator 110. When each of the at least one first varactor is disposed in the gap or split 116 of the radiator 110 operates in the isolation state, the respective first varactor electrically isolates two portions 110A and 110B of radiator 110. When each of the at least one first varactor operates in the connection state, the respective first varactor electrically connects the two portions 110A and 110B of radiator 110.

In one embodiment, the at least one first varactor of the one or more first varactors disposed in the gap or split 116 of the radiator 110 further includes another terminal coupled to an electrical ground through one portion of the radiator 110 on one side of the gap or split 116 of the radiator 110. For example, in one embodiment as shown in FIG. 1, one terminal of first varactor 120(2) may be coupled to shorting port 114 of radiator 110 and another terminal of first varactor 120(2) may be coupled to electrical ground 124 through one portion 110B of the radiator 110 on one side of the gap or split 116 of the radiator 110. When first varactor 120(2) operates in the isolation state, first varactor 120(2) may electrically isolate radiator 110 from electrical ground 124. Moreover, when first varactor 120(2) operates in the connection state, first varactor 120(2) may electrically connect radiator 110 to electrical ground 124.

In an alternative embodiment, the one of the at least one first varactor of the one or more first varactors disposed in the gap or split 116 of the radiator 110 (e.g., first varactor 120(2)) further includes another terminal coupled to a floating point of the radiator 110 through one portion of the radiator 110 on one side of the gap or split 116 of the radiator 110. For instance (not shown), first varactor 120(2) may be disposed in the gap or split 116 of radiator 110. One terminal of first varactor 120(2) may be coupled to shorting port 114 of radiator 110 and another terminal of first varactor 120(2) may be coupled to a floating point of the radiator 110 through one portion 110B of the radiator 110 on one side of the gap or split 116 of the radiator 110. That is, a voltage level of floating point may float and thus may be different from a voltage level of electrical ground 122.

With the utilization of varactors, good linearity can be achieved without producing undesired radiated spurious emission (RSE) issues. In addition, loss of signal strength can be reduced. In addition, the antenna can operate under both transmitting and radiating (Tx and Rx) modes. In addition, high Tx power antenna and low TX power antenna may be also available. Consequently, design specification or requirements may be more readily met.

### Example Implementations

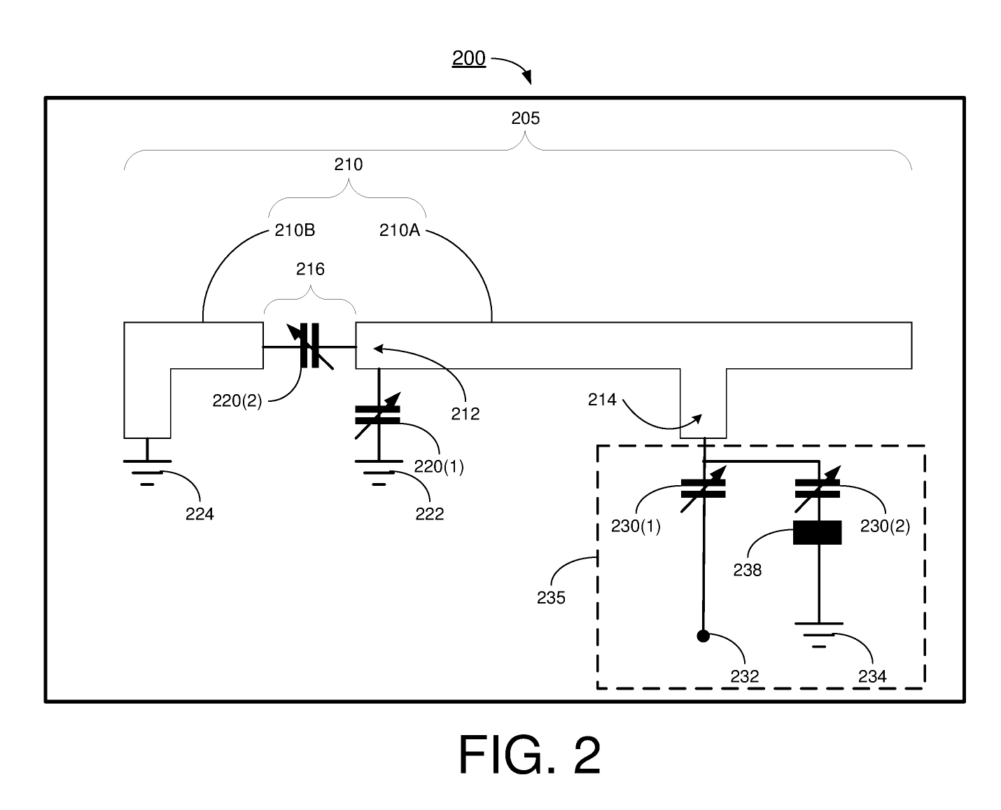

FIG. 2 illustrates an example apparatus 200 in accordance with an implementation of the present disclosure. Apparatus 200 may be a communication apparatus capable of wireless communications. Alternatively or additionally, apparatus 200 may be a portable electronic apparatus, a wearable apparatus or a computing apparatus such as, for example, a smartphone, a smartwatch, a smart bracelet, a smart necklace, a tablet computer, a laptop computer, a notebook computer, a personal digital assistant or the like. Apparatus 200 may include a tunable antenna 205 and a tunable circuit 235, as well as other components that are not necessary relevant to the scope of the present disclosure. Therefore, to avoid obscuring the concept intended to be conveyed herein, these other components of apparatus 200 are not shown in FIG. 2.

Tunable antenna 205 may include a radiator 210 and one or more first varactors. Radiator 210 may include at least one feeding port 214 and at least one shorting port 212. Radiator 210 may also include a gap or split 216. The gap or split 216 may separate radiator 210 into two portions, namely first portion 210A and second portion 210B. Radiator 210 may be an electrically conductive component such as, for example, a metallic frame made of a metallic material. For simplicity and not to obscure the concept intended to be conveyed in FIG. 2, one feeding port 214 and one shorting port 212 instead of multiple feeding ports and/or multiple shorting ports are shown in FIG. 2, although implementations in which radiator 210 having multiple feeding ports and/or multiple shorting ports are also within the scope of the present disclosure. Radiator 210 may be similar or identical to radiator 110 described above.

Each of the one or more first varactors may be coupled to radiator 210 and configured to operate in either the isolation state or the connection state when tunable antenna 205 operates in a RF frequency range which may include one or more ranges of frequencies. The properties, characteristics and functionalities of the one or more first varactors of tunable antenna 205 may be similar or identical to those of the one or more first varactors of tunable antenna 100 described above. Thus, in the interest of brevity a detailed description of the one or more first varactors of tunable antenna 205 is not provided so as to avoid redundancy. For simplicity and not to obscure the concept intended to be conveyed in FIG. 2, a quantity of two of first varactors—namely first varactor 220(1) and first varactor 220(2)—are shown in FIG. 2 although implementations in which tunable antenna 205 having a different quantity of first varactors are also within the scope of the present disclosure.

In the example shown in FIG. 2, one terminal of first varactor 220(1) may be coupled to shorting port 214 of radiator 210 and another terminal of first varactor 220(1) may be coupled to an electrical ground 222. Thus, when first varactor 220(1) operates in the isolation state, first varactor 220(1) may electrically isolate radiator 210 from electrical ground 122. Moreover, when first varactor 220(1) operates in the connection state, first varactor 220(1) may electrically connect radiator 210 to electrical ground 222. Also in the example shown in FIG. 2, alternatively or additionally, first varactor 220(2) may be disposed in the gap or split 216 of radiator 210. One terminal of first varactor 220(2) may be coupled to shorting port 214 of radiator 110 and another terminal of first varactor 220(2) may be coupled to an electric ground 224 (or a floating point). A voltage level of floating point may float and thus may be different from a voltage level of electrical ground 222. When first varactor 220(2) disposed in the gap or split 216 of the radiator 210 operates in the isolation state, first varactor 220(2) electrically isolates two portions 210A and 210B of radiator 210. When first varactor 220(2) operates in the connection state, first varactor 220(2) electrically connects the two portions 210A and 210B of radiator 210.

Tunable circuit 235 may be coupled to tunable antenna 205 and may be configured to tune the one or more ranges of frequencies of tunable antenna 205. Tunable circuit 235 may include at least one matching circuit, and each of the at least one matching circuit may include one or more second varactors. Each of the one or more second varactors may be coupled to radiator 210 and configured to operate in either the isolation state or the connection state when tunable antenna 205 operates in the RF frequency range. For instance, when each of the one or more second varactors is in the connection state, the respective second varactor may be in a high-capacitance state (e.g., with low or no bias) such that the respective second varactor presents a low impedance path, thereby rendering an electrical connection. Moreover, when each of the one or more second varactors is in the isolation state, the respective second varactor may be reverse biased and thus having its capacitance abruptly decreased to result in a high impedance path, thereby causing an electrical isolation. For simplicity and not to obscure the concept intended to be conveyed in FIG. 2, a quantity of one matching circuit having a quantity of two of second varactors—namely second varactor 230(1) and second varactor 230(2)—are shown in FIG. 2 although implementations in which tunable circuit 235 having a different quantity of matching circuit and a different quantity of second varactors are also within the scope of the present disclosure.

At least one second varactor of the one or more second varactors of one of the at least one matching circuit of tunable circuit 235 may include one terminal coupled to a respective feeding port of the at least one feeding port 214 of radiator 210. This second varactor may also include another terminal coupled to a RF port 232. For instance, as shown in FIG. 2, second varactor 230(1) may include one terminal coupled to feeding port 214 and another terminal coupled to RF port 232. When each of the at least one second varactor operates in the isolation state, the respective second varactor may electrically isolate the radiator from RF port 232. When each of the at least one second varactor operates in the connection state, the respective second varactor may electrically connect the radiator to RF port 232. For instance, when second varactor 230(1) operates in the isolation state, second varactor 230(1) may electrically isolate radiator 210 from RF port 232. Moreover, when second varactor 230(1) operates in the connection state, second varactor 230(1) may electrically connect radiator 210 to RF port 232.

Additionally, at least another one second varactor of the one or more second varactors of one of the at least one matching circuit of tunable circuit 235 may include one terminal coupled to a respective feeding port of the at least one feeding port 214 of radiator 210. This second varactor may also include another terminal coupled to an electrical ground 234. For instance, as shown in FIG. 2, second varactor 230(2) may include one terminal coupled to feeding port 214 and another terminal coupled to electrical ground 234. A voltage level of electrical ground 234 may be the same as or different from a voltage level of electrical ground 222. When each of the at least another one second varactor operates in the isolation state, the respective second varactor may electrically isolate radiator 210 from electrical ground 234. When each of the at least another one second varactor operates in the connection state, the respective second varactor may electrically connect radiator 210 to electrical ground 234. For instance, when second varactor 230(2) operates in the isolation state, second varactor 230(2) may electrically isolate radiator 210 from electrical ground 234. Moreover, when second varactor 230(2) operates in the connection state, second varactor 230(2) may electrically connect radiator 210 to electrical ground 234.

In some implementations, the at least one matching circuit of tunable circuit 235 may also include at least one loading element. Each of the at least one loading element may be coupled between a respective one of the at least one second varactor and electrical ground 234 to provide an impedance. For instance, as shown in FIG. 2, a loading element 238 may be coupled between second varactor 230(2) and electrical ground 234 so as to provide an impedance.

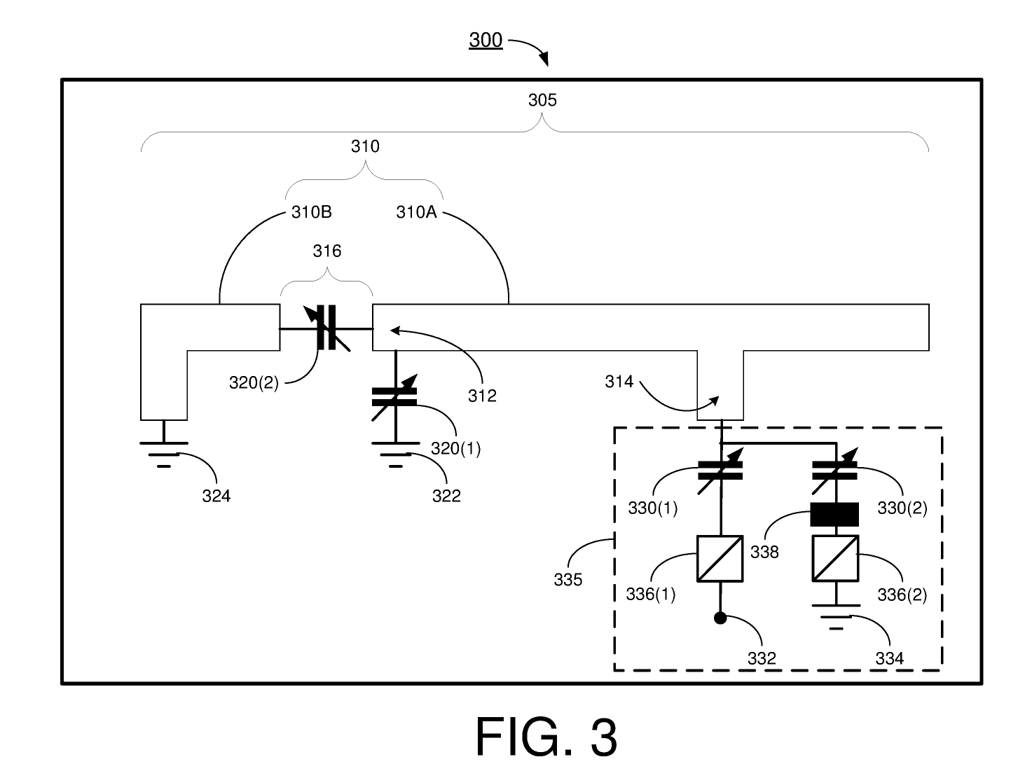

FIG. 3 illustrates an example apparatus 300 in accordance with another implementation of the present disclosure. Apparatus 300 may be a communication apparatus capable of wireless communications. Alternatively or additionally, apparatus 300 may be a portable electronic apparatus, a wearable apparatus or a computing apparatus such as, for example, a smartphone, a smartwatch, a smart bracelet, a smart necklace, a tablet computer, a laptop computer, a notebook computer, a personal digital assistant or the like. Apparatus 300 may include a tunable antenna 305 and a tunable circuit 335, as well as other components that are not necessary relevant to the scope of the present disclosure. Therefore, to avoid obscuring the concept intended to be conveyed herein, these other components of apparatus 300 are not shown in FIG. 3.

Tunable antenna 305 may include a radiator 310 and one or more first varactors. Radiator 310 may include at least one feeding port 314 and at least one shorting port 312. Radiator 310 may also include a gap or split 316. The gap or split 316 may separate radiator 310 into two portions, namely first portion 310A and second portion 310B. Radiator 310 may be an electrically conductive component such as, for example, a metallic frame made of a metallic material. For simplicity and not to obscure the concept intended to be conveyed in FIG. 3, one feeding port 314 and one shorting port 312 instead of multiple feeding ports and/or multiple shorting ports are shown in FIG. 3, although implementations in which radiator 310 having multiple feeding ports and/or multiple shorting ports are also within the scope of the present disclosure. Radiator 310 may be similar or identical to radiator 110 as well as radiator 210 described above.

Each of the one or more first varactors may be coupled to radiator 310 and configured to operate in either the isolation state or the connection state when tunable antenna 305 operates in a RF frequency range which may include one or more ranges of frequencies. The properties, characteristics and functionalities of the one or more first varactors of tunable antenna 305 may be similar or identical to those of the one or more first varactors of tunable antenna 100 described above. Thus, in the interest of brevity a detailed description of the one or more first varactors of tunable antenna 305 is not provided so as to avoid redundancy. For simplicity and not to obscure the concept intended to be conveyed in FIG. 3, a quantity of two of first varactors—namely first varactor 320(1) and first varactor 320(2)—are shown in FIG. 3 although implementations in which tunable antenna 305 having a different quantity of first varactors are also within the scope of the present disclosure.

In the example shown in FIG. 3, one terminal of first varactor 320(1) may be coupled to shorting port 314 of radiator 310 and another terminal of first varactor 320(1) may be coupled to an electrical ground 322. Thus, when first varactor 320(1) operates in the isolation state, first varactor 320(1) may electrically isolate radiator 310 from electrical ground 122. Moreover, when first varactor 320(1) operates in the connection state, first varactor 320(1) may electrically connect radiator 310 to electrical ground 322. Also in the example shown in FIG. 3, first varactor 320(2) may be disposed in the gap or split 316 of radiator 310. One terminal of first varactor 320(2) may be coupled to shorting port 314 of radiator 110 and another terminal of first varactor 320(2) may be coupled to electrical ground 324 (or a floating point). A voltage level of floating point 324 may float and thus may be different from a voltage level of electrical ground 322. When first varactor 320(2) disposed in the gap or split 316 of the radiator 310 operates in the isolation state, first varactor 320(2) electrically isolates two portions 310A and 310B of radiator 310. When first varactor 320(2) operates in the connection state, first varactor 320(2) electrically connects the two portions 310A and 310B of radiator 310.

Tunable circuit 335 may be coupled to tunable antenna 305 and may be configured to tune the one or more ranges of frequencies of tunable antenna 305. Tunable circuit 335 may include at least one matching circuit, and each of the at least one matching circuit may include one or more second varactors. Each of the one or more second varactors may be coupled to radiator 310 and configured to operate in either the isolation state or the connection state when tunable antenna 305 operates in the RF frequency range. For instance, when each of the one or more second varactors is in the connection state, the respective second varactor may be in a high-capacitance state (e.g., with low or no bias) such that the respective second varactor presents a low impedance path, thereby rendering an electrical connection. Moreover, when each of the one or more second varactors is in the isolation state, the respective second varactor may be reverse biased and thus having its capacitance abruptly decreased to result in a high impedance path, thereby causing an electrical isolation. For simplicity and not to obscure the concept intended to be conveyed in FIG. 3, a quantity of one matching circuit having a quantity of two of second varactors—namely second varactor 330(1) and second varactor 330(2)—are shown in FIG. 3 although implementations in which tunable circuit 335 having a different quantity of matching circuit and a different quantity of second varactors are also within the scope of the present disclosure.

At least one second varactor of the one or more second varactors of one of the at least one matching circuit of tunable circuit 335 may include one terminal coupled to a respective feeding port of the at least one feeding port 314 of radiator 310. This second varactor may also include another terminal coupled to a RF port 332. For instance, as shown in FIG. 3, second varactor 330(1) may include one terminal coupled to feeding port 314 and another terminal coupled to RF port 332. When each of the at least one second varactor operates in the isolation state, the respective second varactor may electrically isolate the radiator from RF port 332. When each of the at least one second varactor operates in the connection state, the respective second varactor may electrically connect the radiator to RF port 332. For instance, when second varactor 330(1) operates in the isolation state, second varactor 330(1) may electrically isolate radiator 310 from RF port 332. Moreover, when second varactor 330(1) operates in the connection state, second varactor 330(1) may electrically connect radiator 310 to RF port 332.

Additionally, at least another one second varactor of the one or more second varactors of one of the at least one matching circuit of tunable circuit 335 may include one terminal coupled to a respective feeding port of the at least one feeding port 314 of radiator 310. This second varactor may also include another terminal coupled to an electrical ground 334. For instance, as shown in FIG. 3, second varactor 330(2) may include one terminal coupled to feeding port 314 and another terminal coupled to electrical ground 334. A voltage level of electrical ground 334 may be the same as or different from a voltage level of electrical ground 322. When each of the at least another one second varactor operates in the isolation state, the respective second varactor may electrically isolate radiator 310 from electrical ground 334. When each of the at least another one second varactor operates in the connection state, the respective second varactor may electrically connect radiator 310 to electrical ground 334. For instance, when second varactor 330(2) operates in the isolation state, second varactor 330(2) may electrically isolate radiator 310 from electrical ground 334. Moreover, when second varactor 330(2) operates in the connection state, second varactor 330(2) may electrically connect radiator 310 to electrical ground 334.

In some implementations, the at least one matching circuit of tunable circuit 335 may also include at least one switching element, with each of the at least one switching element coupled between a respective one of the at least one second varactor and RF port 332 to switch the respective one of the at least one second varactor between being electrically connected to RF port 332 and being electrically isolated from RF port 332. For instance, as shown in FIG. 3, a switching element 336(1) may be coupled between second varactor 330(1) and RF port 332 such that switching element 336(1) may switch on and off to switch second varactor 330(1) between being electrically connected to RF port 332 and being electrically isolated from RF port 332.

Alternatively or additionally, the at least one matching circuit of tunable circuit 335 may further include at least one switching element, with each of the at least one switching element coupled between a respective one of the at least one second varactor and electrical ground 334 to switch the respective one of the at least one second varactor between being electrically connected to electrical ground 334 and being electrically isolated from electrical ground 334. For instance, as shown in FIG. 3, a switching element 336(2) may be coupled between second varactor 330(2) and electrical ground 334 such that switching element 336(2) may switch on and off to switch second varactor 330(2) between being electrically connected to electrical ground 334 and being electrically isolated from electrical ground 334.

Alternatively or additionally, the at least one matching circuit of tunable circuit 335 may also include at least one loading element. Each of the at least one loading element may be coupled between a respective one of the at least one second varactor and electrical ground 334 to provide an impedance. For instance, as shown in FIG. 3, a loading element 338 may be coupled between second varactor 330(2) and electrical ground 334 so as to provide an impedance.

With the utilization of varactors, good linearity can be achieved without producing undesired radiated spurious emission (RSE) issues. In addition, loss of signal strength can be reduced. In addition, the antenna can operate under both transmitting and radiating (Tx and Rx) modes. In addition, high Tx power antenna and low TX power antenna may be also available. Consequently, design specification or requirements may be more readily met.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A communication apparatus, comprising:
a tunable antenna comprising:
a radiator comprising at least one feeding port and at least one shorting port; and
one or more first varactors, each of the one or more first varactors coupled to the radiator and configured to operate in either an isolation state or a connection state when the tunable antenna operates in a radio-frequency (RF) frequency range.

2. The communication apparatus of claim 1, wherein at least one first varactor of the one or more first varactors comprises one terminal coupled to a respective shorting port of the at least one shorting port of the radiator.

3. The communication apparatus of claim 2, wherein the at least one first varactor of the one or more first varactors further comprises another terminal coupled to an electrical ground, wherein, when each of the at least one first varactor operates in the isolation state, the respective first varactor electrically isolates the radiator from the electrical ground, and wherein, when each of the at least one first varactor operates in the connection state, the respective first varactor electrically connects the radiator to the electrical ground.

4. The communication apparatus of claim 2, wherein the radiator further comprises a gap or split, and wherein one of the at least one first varactor of the one or more first varactors is disposed in the gap or split of the radiator.

5. The communication apparatus of claim 4, wherein when the one of the at least one first varactor disposed in the gap or split of the radiator operates in the isolation state, the respective first varactor electrically isolates two portions of the radiator on two sides of the gap or split of the radiator, and wherein when the one of the at least one first varactor operates in the connection state, the respective first varactor electrically connects the two portions of the radiator on the two sides of the gap or split of the radiator.

6. The communication apparatus of claim 4, wherein the one of the at least one first varactor of the one or more first varactors disposed in the gap or split of the radiator further comprises another terminal coupled to an electrical ground through one portion of the radiator on one side of the gap or split of the radiator.

7. The communication apparatus of claim 4, wherein the one of the at least one first varactor of the one or more first varactors disposed in the gap or split of the radiator further comprises another terminal coupled to a floating point of the radiator through one portion of the radiator on one side of the gap or split of the radiator.

8. The communication apparatus of claim 1, wherein the radiator further comprises a gap or split, and wherein at least one first varactor of the one or more first varactors is disposed in the gap or split of the radiator.

9. The communication apparatus of claim 1, further comprising:
a tunable circuit coupled to the tunable antenna and configured to match one or more ranges of frequencies of the tunable antenna, the tunable circuit comprising at least one matching circuit, each of the at least one matching circuit comprising one or more second varactors, each of the one or more second varactors configured to operate in either the isolation state or the connection state when the tunable antenna operates in the RF frequency range.

10. The communication apparatus of claim 9, wherein at least one second varactor of the one or more second varactors of one of the at least one matching circuit comprises one terminal coupled to a respective feeding port of the at least one feeding port of the radiator.

11. The communication apparatus of claim 10, wherein the at least one second varactor of the one or more second varactors further comprises another terminal coupled to a RF port, wherein, when each of the at least one second varactor operates in the isolation state, the respective second varactor electrically isolates the radiator from the RF port, and wherein, when each of the at least one second varactor operates in the connection state, the respective second varactor electrically connects the radiator to the RF port.

12. The communication apparatus of claim 11, wherein the at least one matching circuit further comprises at least one switching element, each of the at least one switching element coupled between a respective one of the at least one second varactor and the RF port and configured to switch the respective one of the at least one second varactor between being electrically connected to the RF port and being electrically isolated from the RF port.

13. The communication apparatus of claim 10, wherein the at least one second varactor of the one or more second varactors further comprises another terminal coupled to an electrical ground, wherein, when each of the at least one second varactor operates in the isolation state, the respective second varactor electrically isolates the radiator from the electrical ground, and wherein, when each of the at least one second varactor operates in the connection state, the respective second varactor electrically connects the radiator to the electrical ground.

14. The communication apparatus of claim 13, wherein the at least one matching circuit further comprises at least one loading element, each of the at least one loading element coupled between a respective one of the at least one second varactor and the electrical ground and configured to provide an impedance.

15. The communication apparatus of claim 13, wherein the at least one matching circuit further comprises at least one switching element, each of the at least one switching element coupled between a respective one of the at least one second varactor and the electrical ground and configured to switch the respective one of the at least one second varactor between being electrically connected to the electrical ground and being electrically isolated from the electrical ground.

16. A communication apparatus, comprising:
a tunable antenna comprising:
a radiator comprising at least one feeding port and at least one shorting port, the radiator further comprising a gap or split;
a first varactor coupled between a respective one of the at least one shorting port of the radiator and an electrical ground, and the first varactor configured to operate in either an isolation state or a connection state when the tunable antenna operates in a radio-frequency (RF) frequency range; and
a second varactor disposed in the gap or split of the radiator, and the second varactor configured to operate in either the isolation state or the connection state when the tunable antenna operates in the RF frequency range; and
a tunable circuit coupled to the tunable antenna and configured to match one or more ranges of frequencies of the tunable antenna, the tunable circuit comprising at least one matching circuit, the at least one matching circuit comprising:
a third varactor coupled between a respective one of the at least one feeding port and a RF port, the third varactor configured to operate in either the isolation state or the connection state when the tunable antenna operates in the RF frequency range.

17. The communication apparatus of claim 16, wherein the second varactor comprises one terminal coupled to a respective one of the at least one shorting port of the radiator.

18. The communication apparatus of claim 17, wherein when the second varactor operates in the isolation state, the second varactor electrically isolates two portions of the radiator on two sides of the gap or split of the radiator, and wherein when the second varactor operates in the connection state, the second varactor electrically connects the two portions of the radiator on the two sides of the gap or split of the radiator.

19. The communication apparatus of claim 17, wherein the second varactor further comprises another terminal coupled to an electrical ground through one portion of the radiator on one side of the gap or split of the radiator.

20. The communication apparatus of claim 17, wherein the second varactor further comprises another terminal coupled to a floating point of the radiator through one portion of the radiator on one side of the gap or split of the radiator.

21. The communication apparatus of claim 16, wherein the at least one matching circuit further comprises:
a fourth varactor coupled between a respective one of the at least one feeding port and the electrical ground, the fourth varactor configured to operate in either the isolation state or the connection state when the tunable antenna operates in the RF frequency range,
wherein, when the third varactor operates in the isolation state, the third varactor electrically isolates the radiator from the RF port,
wherein, when the third varactor operates in the connection state, the third varactor electrically connects the radiator to the RF port,
wherein, when the fourth varactor operates in the isolation state, the fourth varactor electrically isolates the radiator from the electrical ground, and
wherein, when the fourth varactor operates in the connection state, the fourth varactor electrically connects the radiator to the electrical ground.

22. The communication apparatus of claim 21, wherein the at least one matching circuit further comprises:
at least one loading element coupled between the fourth varactor and the electrical ground and configured to provide an impedance.

23. The communication apparatus of claim 21, wherein the at least one matching circuit further comprises:
a first switching element coupled between the third varactor and the RF port and configured to switch the third varactor between being electrically connected to the RF port and being electrically isolated from the RF port; and
a second switching element coupled between the fourth varactor and the electrical ground and configured to switch the fourth varactor between being electrically connected to the electrical ground and being electrically isolated from the electrical ground.
